(19) United States
(12) Patent Application Publication
(10) Pub. No.: US 2026/0217142 A1
(43) Pub. Date: Jul. 30, 2026

(54) STOWABLE ELECTRIC VEHICLE CHARGING PORT COVER

(71) Applicant: FCA US LLC, Auburn Hills, MI (US)

(72) Inventors: Sarath Chander CB, Chennai (IN); Vinoth Sankar, Chennai (IN)

(21) Appl. No.: 19/040,363

(22) Filed: Jan. 29, 2025

(51) Int. Cl. B60L 53/16; H01R 13/453

(52) U.S. Cl. CPC B60L 53/16; H01R 13/4532; H01R 2201/26

(57) ABSTRACT

A vehicle includes a vehicle body, a charging port carried by the vehicle body within a cavity, a door carried by the vehicle body and movable from a closed position in which the door covers the cavity and an open position in which the door does not cover the cavity to permit access to the charging port, and a cover. The cover is coupled to the vehicle body at a first side and to the door at a second side. The cover is in a retracted position and at least partly received in the cavity when the door is in the closed position and the cover is in an extended position when the door is in the open position, and when the cover is in the extended position, and the cover spans a space between an inner surface of the door and the vehicle body.

### FIELD

The present disclosure relates to a cover for a charging port of an electric vehicle.

### BACKGROUND

Outdoor electric vehicle charging stations are often open to the environment. Charging an electric vehicle can take a long time and this leaves the vehicle charge port area open to snow, ice, water and other contaminants that can foul the area of a vehicle charge port and may interfere with the charging connection between a charging connector and the vehicle charge port.

### SUMMARY

In at least some implementations, a vehicle includes a vehicle body defined in part by one or more body panels, a charging port carried by the vehicle body within a cavity of the vehicle body, a door carried by the vehicle body and movable from a closed position in which the door covers the cavity and prevents access to the charging port and an open position in which the door does not cover the cavity to permit access to the charging port, and a cover. The cover is coupled to the vehicle body at a first side of the cover and to the door at a second side of the cover. The cover is in a retracted position and at least partly received in the cavity when the door is in the closed position and the cover is in an extended position when the door is in the open position, and when the cover is in the extended position, and the cover spans a space between an inner surface of the door and the vehicle body.

In at least some implementations, the cover is releasably coupled to the vehicle body and to the door. In at least some implementations, the cover is connected by snap-fit connectors to one or both of the vehicle body and the door. In at least some implementations, the cover includes a rib adapted to be snap-fit into a connector on the vehicle body or on the door.

In at least some implementations, the cover is formed from an at least partially transparent material so that the charging port is visible through the cover.

In at least some implementations, the cover has an upper surface that is without perforations and which prevents liquid from passing through the cover. In at least some implementations, the cover includes one or more pleats about which the cover folds when the door is moved to the closed position.

In at least some implementations, the cover is formed from a polymeric material and has multiple sections that are defined at least in part by supports that extend from a junction between the first side and the second side and extend to an opposite side of the cover that spans between the first side and the second side.

In at least some implementations, the door has an outer surface that is flush with an outer surface of an adjacent one of the body panels, and wherein the cover is received between the inner surface and the vehicle body when the door is in the closed position.

In at least some implementations, the first side is parallel to one of the body panels and the second side is parallel to the inner surface of the door.

In at least some implementations, a cover for a vehicle charge port includes a first side including one or more first side connection features adapted to be coupled a vehicle body, and a second side including one or more second side connection features adapted to be coupled an inner surface of a door movable relative to a charging port of the vehicle, and a third side that spans between the first side and the second side. The cover has a retracted position in which the second side is a first distance from the first side and an extended position in which the second side is a second distance from the first side and the second distance is greater than the first distance.

In at least some implementations, the cover is formed from a flexible material that folds or bends when the cover is moved from the extended position to the retracted position.

In at least some implementations, the cover is formed from a transparent or translucent material permitting part of a body of the vehicle to be viewed through the cover.

In at least some implementations, the first side is parallel to or within 10 degrees of parallel to the second side in the retracted position.

In at least some implementations, the first side is at an angle of greater than 60 degrees to the second side in the extended position.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a side view of an electric vehicle parked near a battery charging unit;

FIG. 2 is a perspective view showing part of the vehicle including a charging port door, a charging port and a cover with the door partially open and the cover partially extended;

FIG. 3 is a view similar to FIG. 2 and showing the door fully open and the cover fully extended;

FIG. 4 is a view similar to FIG. 3 showing a charge connector of the battery charging unit plugged into the charging port; and

FIG. 5 is a view similar to FIG. 2 showing a cover having pleats or folds to facilitate retraction and extension of the cover.

### DETAILED DESCRIPTION

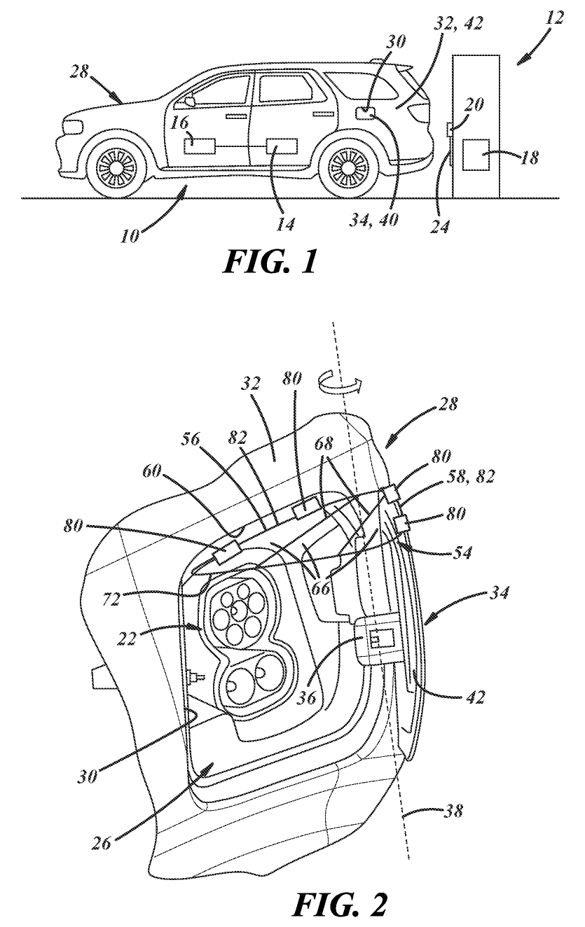

Referring in more detail to the drawings, FIG. 1 illustrates an electric vehicle 10 parked near a battery charging unit 12. The vehicle 10 has one or more batteries 14 that provide electrical power to one or more motors 16 used to propel the vehicle 10, and the batteries can provide power to other vehicle electrical components and systems. The batteries 14 are rechargeable which may be done via the charging unit 12. The charging unit 12 has a power supply 18, a charge connector 20 adapted to be releasably connected to a vehicle charging port 22 (FIG. 2), and a charge cable 24 connected between the power supply 18 and the charge connector 20. Thus, when the charge connector is coupled to the vehicle charging port 22, electricity can be supplied to the vehicle batteries 14 to recharge the batteries 14.

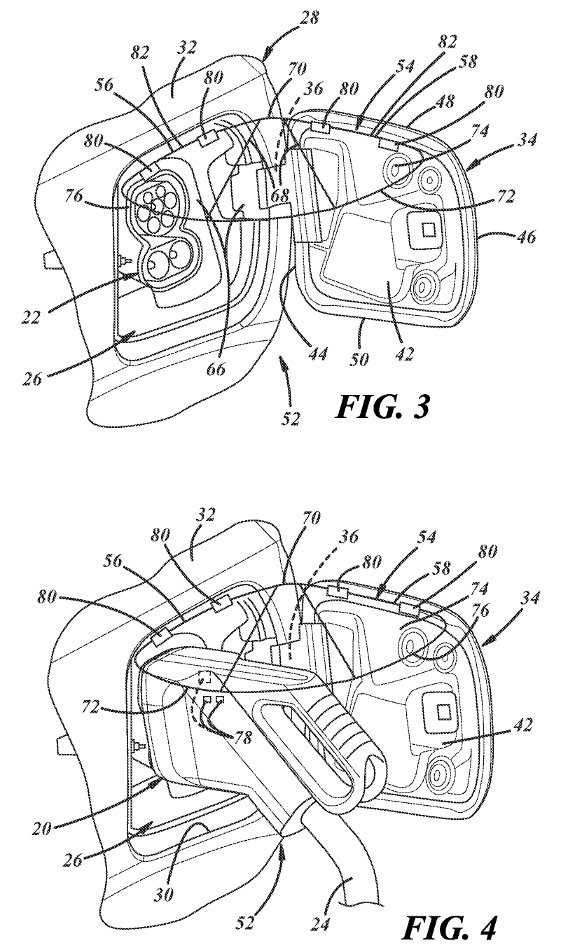

As shown in FIGS. 2 and 3, the vehicle charging port 22 is received within a cavity 26 of the vehicle body 28, which may be defined in part by an opening 30 in one or more vehicle body panels 32 or other vehicle body components, and a charging port door 34 that overlies the opening 30 in a closed position (shown in FIG. 1) and which is movable to an open position (FIGS. 3 and 4) to permit access to the charging port 22. The door 34 may be coupled to the vehicle body 28 by a hinge 36 or other connector permitting movement of the door 34 relative to the body panel. In at least some implementations, the hinge 36 permits pivoted or rotational movement of the door 34 about or generally about an axis of rotation 38. The hinge 36 may permit some swinging/lateral movement (e.g. perpendicular to the axis 38) during the pivoting movement of the door 34 between its open and closed positions (that is, the door 34 need not simply rotate about the axis 38).

The door 34 has an outer surface 40 (FIG. 1) that may define part of an exterior 41 of the vehicle body 28, and which may be flush or generally flush with the adjacent panel(s) 32 of the vehicle body 28 when the door 34 is in the closed position. The door 34 has an opposite inner surface 42 that faces inwardly, toward the charging port 22 and which is hidden from view from outside the vehicle 10 when the door 34 is closed. Referring to FIG. 3, in the example shown, the door 34 is connected to the hinge 36 at the inner surface 42 and at or adjacent to a first side edge 44 of the door 34. The door 34 has an opposite, second side edge 46, an upper edge 48 and a lower edge 50 opposite the upper edge 48. While shown as being generally rectangular (e.g. a rounded rectangle), the door 34 may have any desired shape. When the door 34 is in the open position, the second side edge 46 is spaced farther from the opening than is the first side edge 44, and the inner surface 42 is disposed at an included angle sufficient to permit access to the charging port 22 and coupling of the charging unit connector 20 to the charging port 22. This leaves an open space 52 between the inner surface 42 and the charging port 22, and as shown in FIG. 4, the charge connector 20 is moved into this space 52 when it is coupled to the vehicle charging port 22.

Many charging units 12 are located outside and have little or no overhead protection for the area in which a vehicle is parked at the charging unit. Thus, contaminants like rain, snow and wind-blown debris can find their way into the area of the charging port 22 and cavity 26 when a charging session is occurring which requires that the charging port door 34 be open. Such contaminants can foul the area of the charging port 22 (e.g. the cavity 26 in which the charging port 22 is located), and can collect on or near an interface area between the charge connector 20 and the charging port 22 and potentially interfere with charging of the vehicle 10.

To inhibit contaminants from entering the cavity 26 and the space between the open door 34 and the charging port 22, a cover 54 is provided. The cover 54 is connected to the vehicle body 28 and to the door 34. In at least some implementations, the cover 54 is connected along a first side 56 to the vehicle body 28 at an upper portion of the cavity 26, at a height above the height of the charging port 22. Further, the cover 54 is connected along a second side 58 to the door 34 at an upper portion of the door 34 and at a height above the height of the charging port 22. In this way, the cover 54 is positioned above the charging port 22, and, as shown in FIG. 4, above the height of and over the charge connector 20 when coupled to the charging port 22.

Further, the cover 54 may be connected to the vehicle body 28 within the cavity 26, such as to an upper wall 60 (FIG. 2) that defines part of the cavity 26 and that extends inwardly, away from an exterior of the body panel 32 (or panels) in which the cavity 26 is provided. And the cover 54 may be connected to the inner surface 42 of the door 34. In this way, the cover 54 may be received in the cavity 26 when the door 34 is closed, so that the cover 54 is concealed from view when the door 34 is closed.

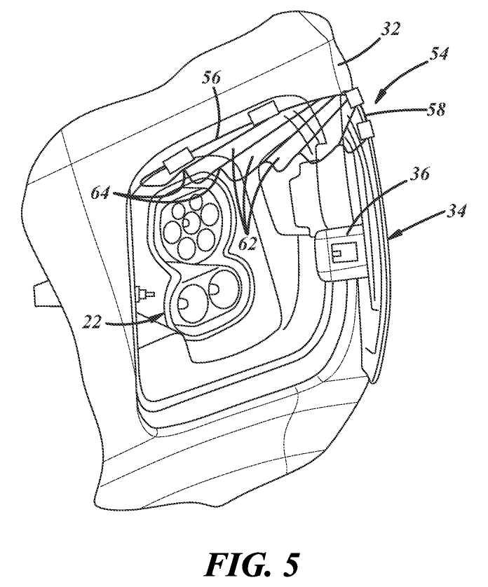

To permit the cover 54 to be received in the cavity 26 when the door 34 is closed, and to span the area between the door 34 and vehicle panel when the door 34 is open, the cover 54 may be formed to fold or flex or otherwise move to a retracted position or stowed position in which the cover 54 is received inboard of the door 34 and within the cavity 26 when the door 34 is moved to the closed position. And the cover 54 is formed to unfold or straighten to an extended position when the door 34 is moved toward the open position. The cover 54 can be formed from a flexible material to permit the desired movement, or in sections 62 that are connected at pleats or folds 64, such as accordion folds as shown in the example of FIG. 5. In at least some implementations, the first side 56 is parallel to or within 10 degrees of parallel to the second side 58 when the cover 54 is in the retracted position, and the first side 56 is at an angle of at least sixty degrees to the second side 58 when the cover 54 is in the extended position.

In the implementation shown in FIGS. 2-4, the cover 54 is formed from a polymeric material and has three interconnected sections 66. The sections 66 may be defined in part by supports 68 that extend from a junction 70 between the first and second sides 56, 58 and extend to a third, outer side 72 of the cover 54 that may be arcuate (e.g. defined by a radius centered in the junction 70 or at the axis 38) and that spans between the first and second sides 56, 58. The cover 54 may be formed of a single piece of material with the supports 68 connected to the cover material to, for example, improve the rigidity of the cover 54, and to assist in proper folding of the cover 54 to the retracted position within the cavity 26. Or the sections 66 may be separate pieces of material that are joined to the supports 68 to define a unitary component.

In at least some implementations, the cover 54 is formed without perforations so that an upper surface 74 of the cover 54 is continuous and complete. The cover 54 may be formed of a material that does not permit liquid to pass through it to, for example, protect the charging port 22 area from rain and snow. In at least some implementations, the cover 54 is formed from a polymeric material, such as but not limited to polyester or vinyl materials. And the cover 54 may be a flat sheet of material having flat upper and lower surfaces 74, 76, and be thin, and may have a weight of 270GSM or more.

To permit the charge connector 20 to be viewable through the cover 54, the cover 54 may be transparent or translucent. Some charge connectors 20 include lights or other indicator(s) 78 (FIG. 4) to indicate a charge status (e.g. that a charging cycle is occurring might be indicated by a green light while the absence of active charging may be noted by a red light). The charge connector 20 may include status indicators 78 indicating an amount of charging that has occurred (e.g. as a percentage of a total/complete charge which may be indicated in any desired manner such as a specific number or in steps or quartiles (e.g. 25, 50, 75 and 100)). Further, verifying that the charge connector 20 is properly connected to the charging port 22, as well as connecting and disconnecting the charge connector 20 from the charging port 22 is facilitated by being able to see through the cover 54.

The cover 54 may be removable from the vehicle 10 to facilitate repair or replacement of the cover 54. In at least some implementations, the cover 54 is coupled to the vehicle 10 by one or more snap-fit or press-fit connections. In the example shown, one or more connectors 80 are attached to each of the vehicle 10 and the door 34, and the first and second sides 56, 58 the cover 54 include features 82 that are adapted to be snap-fit into the connectors 80 to releasably secure the cover 54 to the connectors 80. The features in the illustrated example of the cover 54 are defined by ribs 82 provided at the first and second sides 56, 58 of the cover 54, with the ribs 82 having greater thickness than the adjacent cover material and being of a size and shape for receipt in the connectors 80. For example, the connectors 80 may include an opening or inlet that is smaller in size than the ribs 82, and the connectors 80 may be flexible and resilient to flex and allow the ribs 82 to pass through the opening and to resiliently return toward the unflexed state to overlap and retain the ribs 82.

Of course, other snap-fit or press-fit or interference fit arrangements may be used. The ribs 82 may be pressed or snapped into and pulled out of the connectors 80 to connect and remove the cover 54 form the vehicle 10, as desired. Of course, other connections may be used, including those defined by fasteners like clips, bolts or screws or staples or button or snaps or zippers, by way of non-limiting examples. Further, instead of a snap fit, one or both ribs 82 could be slidably received in a channel-shaped connector or slot to connect the cover 54 to the vehicle 10, or otherwise removably/releasably connected to the vehicle 10. And the cover may include the connectors 80 with complementary connection features 82 provides on the vehicle body 28 and the door 34.

The cover 54 moves with the charge port door 34 so that it is automatically extended to cover the charge port area 52 when the door 34 is opened, and automatically stowed in the cavity 26 when the door is closed. Thus, a user need not fuss with installing a cover after coupling a charge connector 20 to the charge port 22 and can simply open the door and then couple the charge connector 20 to the vehicle, with the cover already in place.

What is claimed is:

1. A vehicle, comprising:
a vehicle body defined in part by one or more body panels;
a charging port carried by the vehicle body within a cavity of the vehicle body;
a door carried by the vehicle body and movable from a closed position in which the door covers the cavity and prevents access to the charging port and an open position in which the door does not cover the cavity to permit access to the charging port; and
a cover coupled to the vehicle body at a first side of the cover and coupled to the door at a second side of the cover, wherein the cover is in a retracted position and at least partly received in the cavity when the door is in the closed position and the cover is in an extended position when the door is in the open position, and when the cover is in the extended position, the cover spans a space between an inner surface of the door and the vehicle body.

2. The vehicle of claim 1 wherein the cover is releasably coupled to the vehicle body and to the door.

3. The vehicle of claim 2 wherein the cover is connected by snap-fit connectors to one or both of the vehicle body and the door.

4. The vehicle of claim 1 wherein the cover is formed from an at least partially transparent material so that the charging port is visible through the cover.

5. The vehicle of claim 1 wherein the cover has an upper surface that is without perforations and which prevents liquid from passing through the cover.

6. The vehicle of claim 5 wherein the cover includes one or more pleats about which the cover folds when the door is moved to the closed position.

7. The vehicle of claim 3 wherein the cover includes a rib adapted to be snap-fit into a connector on the vehicle body or on the door.

8. The vehicle of claim 1 wherein the cover is formed from a polymeric material and has multiple sections that are defined at least in part by supports that extend from a junction between the first side and the second side and extend to an opposite side of the cover that spans between the first side and the second side.

9. The vehicle of claim 1 wherein the door has an outer surface that is flush with an outer surface of an adjacent one of the body panels, and wherein the cover is received between the inner surface and the vehicle body when the door is in the closed position.

10. The vehicle of claim 1 wherein the first side is parallel to one of the body panels and the second side is parallel to the inner surface of the door.

11. A cover for a vehicle charge port, comprising:
a first side including one or more first side connection features adapted to be coupled a vehicle body,
a second side including one or more second side connection features adapted to be coupled an inner surface of a door movable relative to a charging port of the vehicle; and
a third side that spans between the first side and the second side, the cover has a retracted position in which the second side is a first distance from the first side and an extended position in which the second side is a second distance from the first side and the second distance is greater than the first distance.

12. The cover of claim 11 wherein the cover is formed from a flexible material that folds or bends when the cover is moved from the extended position to the retracted position.

13. The cover of claim 11 wherein the cover is formed from a transparent or translucent material permitting part of a body of the vehicle to be viewed through the cover.

14. The cover of claim 11 wherein an upper surface of the cover is without perforations and prevents liquid from passing through the cover.

15. The cover of claim 14 wherein one or more pleats are provided between the first side and the second side and about which the cover folds when moved to the retracted position.

16. The cover of claim 11 which includes a rib at one or both of the first side and the second side, the rib being adapted to be snap-fit into a connector.

17. The cover of claim 11 wherein the cover is formed from a polymeric material and has multiple sections that are defined at least in part by supports that extend from a junction between the first side and the second side and extend to an opposite side of the cover that spans between the first side and the second side.

18. The cover of claim 11 wherein the first side is parallel to or within 10 degrees of parallel to the second side in the retracted position.

19. The cover of claim 11 wherein the first side is at an angle of greater than 60 degrees to the second side in the extended position.
